(19) United States
(12) Patent Application Publication
(10) Pub. No.: US 2024/0322367 A1
(43) Pub. Date: Sep. 26, 2024

(54) SEPARATOR AND ELECTROCHEMICAL DEVICE INCLUDING THE SEPARATOR

(71) Applicants: SK INNOVATION CO., LTD., Seoul (KR); SK IE TECHNOLOGY CO., LTD., Seoul (KR)

(72) Inventors: Kyu Young CHO, Daejeon (KR); Yun Bong KIM, Daejeon (KR); Eun Ji OH, Daejeon (KR)

(21) Appl. No.: 18/611,217

(22) Filed: Mar. 20, 2024

(30) Foreign Application Priority Data
Mar. 20, 2023 (KR) 10-2023-0035915

(51) Int. Cl. H01M 50/443; H01M 50/411; H01M 50/431; H01M 50/454

(52) U.S. Cl. CPC H01M 50/443; H01M 50/411; H01M 50/431; H01M 50/454

(57) ABSTRACT

Separators and electrochemical devices including the separators are disclosed. In an embodiment, a separator may include a porous substrate; an inorganic particle layer including inorganic particles that are disposed on at least one surface of the porous substrate and connected to each other to form pores between the inorganic particles; and an adhesive layer including organic particles having a plurality of protrusion parts and a plurality of valley parts connected to each other to form pores.

### PRIORITY CLAIM AND CROSS-REFERENCE TO RELATED APPLICATIONS

This patent document claims the priority and benefits of Korean Patent Application No. 10-2023-0035915, filed on Mar. 20, 2023, the disclosure of which is incorporated herein by reference in its entirety.

### TECHNICAL FIELD

The disclosed technology relates to a separator and an electrochemical device including the separator.

### BACKGROUND

To ensure high temperature stability of a separator, a ceramic coated separator (CCS) having a porous inorganic particle layer formed on one or both surfaces of a porous substrate is used. The ceramic coated separator has excellent heat resistance due to its low heat shrinkage rate at a high temperature, and thus it is applied to a large battery system for electric vehicles (EVs).

### SUMMARY

The disclosed technology can be implemented in some embodiments to provide a separator with excellent electrode adhesion, anti-blocking properties, and air permeability, and an electrochemical device including the separator. In an embodiment of the disclosed technology, a separator may have excellent electrode adhesion, anti-blocking properties, and air permeability even at a small thickness.

In an embodiment, a separator having an adhesive layer thickness of 2 μm or less and a total separator thickness of 20 μm or less or 15 μm or less may be provided, and a separator having excellent electrode adhesion, anti-blocking properties, and air permeability within the range, and an electrochemical device including the separator are intended to be provided.

In one general aspect, a separator includes: a porous substrate; an inorganic particle layer disposed on at least one surface of the porous substrate, in which inorganic particles are connected to each other to form pores between the inorganic particles; and an adhesive layer disposed on the inorganic particle layer, in which organic particles having a plurality of protrusion parts and a plurality of valley parts are connected to each other to form pores.

In an example embodiment, a ratio of an average particle diameter (D50) of the organic particles to an average particle diameter (D50) of the inorganic particles may be 0.5 to 3, or 0.5 to 1.5, where D50 is a particle diameter below which 50% of the total particles are found.

In an example embodiment, the organic particles may have D50 of 0.1 μm to 2 μm or 0.1 μm to 1.5 μm.

In an example embodiment, in a particle size distribution of the organic particles, D10/D90 value may be 0.3 to 0.9. In one example, D10 is a particle diameter below which 10% of the total organic particles are found, and D90 is a particle diameter below which 90% of the total organic particles are found.

In an example embodiment, the organic particles may have a glass transition temperature (Tg) of 50 to 90° C.

In an example embodiment, the adhesive layer may have a thickness ranging from 0 μm to 2 μm.

In an example embodiment, the organic particles may include at least one of: secondary particles in which primary particles are aggregated with each other by surface melting to form a plurality of protrusion parts and a plurality of valley parts; or primary particles having a plurality of protrusion parts and a plurality of valley parts on a surface of the primary particles.

In an example embodiment, the adhesive layer may include 70 wt % or more of the organic particles based on the total weight of the adhesive layer.

In an example embodiment, the adhesive layer may include 0.2 to 2.0 g/m² of the organic particles.

In an example embodiment, the separator may have an electrode adhesive strength of 1.5 gf/15 mm to 4.0 gf/15 mm, wherein the electrode adhesive strength is measured by laminating the separator on a carbon sheet (e.g., TOYO Tanso Korea, PF-20HP) having a thickness of 200 μm so that the adhesive layer of the separator faces the carbon sheet, adhering the separator by compression at 80° C., 20 MPa for 30 seconds with a heat press, and peeling off the separator at 180° using universal testing machine (UTM) equipment (e.g., INSTRON) in accordance with ASTM D903.

In an example embodiment, the separator may have an amount of change in air permeability ΔG of 50 sec/100 cc or less as measured by the following equation:

ΔG=G₁−G₂

wherein G₁ is a Gurley permeability of a separator in which an inorganic particle layer and an adhesive layer are sequentially laminated on both surfaces of a porous substrate, and G₂ is a Gurley permeability of the porous substrate itself. The Gurley permeability is measured using a densometer (e.g., Toyoseiki) in accordance with the standard of ASTM D 726, and its unit is sec/100 cc.

In an example embodiment, when two sheets of separators are disposed so that the adhesive layers face each other, compressed with a pressure of 7.5 MPa at a temperature of 60° C. for 1 hour, and peeled off at 180° in accordance with ASTM D903, the adhesive layers are separated as they are without a phenomenon in which the adhesive layers are adhered to each other and partially or completely peeled off, and blocking is not caused.

In another general aspect, an electrochemical device includes the separator of the example embodiment described above.

In another general aspect, an electrochemical device comprising a separator comprising: a porous substrate;

an inorganic particle layer disposed on at least one surface of the porous substrate and including inorganic particles connected to each other to form pores between the inorganic particles;

and an adhesive layer disposed on the inorganic particle layer and including organic particles having a plurality of protrusion parts and a plurality of valley parts connected to each other to form pores.

In an example embodiment, wherein a ratio of an average particle diameter (D50) of the organic particles to an average particle diameter (D50) of the inorganic particles is 0.5 to 1.5, where D50 is a particle diameter below which 50% of the total particles are found.

In an example embodiment, wherein the organic particles have D50 of 0.1 to 1.5 μm.

In an example embodiment, wherein a particle size distribution of the organic particles (D10/D90) is 0.3 to 0.9, where D10 is a particle diameter below which 10% of the total organic particles are found, and D90 is a particle diameter below which 90% of the total organic particles are found.

In an example embodiment, wherein the organic particles have a glass transition temperature (Tg) of 50 to 90° C.

In an example embodiment, wherein the adhesive layer has a thickness ranging from 0 μm to 2 μm.

In an example embodiment, wherein the organic particles are at least one of: secondary particles in which primary particles are aggregated with each other by surface melting to form a plurality of protrusion parts and a plurality of valley parts; or primary particles having a plurality of protrusion parts and a plurality of valley parts on a surface of the primary particles.

In an example embodiment, wherein the adhesive layer includes 70 wt % or more of the organic particles based on the total weight of the adhesive layer.

Other features and aspects will be apparent from the following detailed description, the drawings, and the claims.

### BRIEF DESCRIPTION OF THE DRAWINGS

FIG. 1 shows a shape of organic particles based on an example embodiment of the disclosed technology that is observed using a scanning electron microscope (SEM).

FIG. 2 illustrates a shape of the organic particle based on an example embodiment of the disclosed technology.

FIG. 3 shows an adhesive layer of a separator of Example 1 that is observed by SEM.

FIG. 4 shows an adhesive layer of a separator of Comparative Example 1 that is observed by SEM.

FIG. 5 shows an adhesive layer of a separator of Comparative Example 2 that is observed by SEM.

FIG. 6 shows an adhesive layer of a separator of Comparative Example 3 that is observed by SEM.

### DETAILED DESCRIPTION

Section headings are used in the present document only for ease of understanding and do not limit scope of the embodiments to the section in which they are described.

Features of the disclosed technology disclosed in this patent document are described by example embodiments with reference to the accompanying drawings. However, the disclosed technology is not limited to specific embodiments.

Ceramic coated separators lack adhesion to electrodes, so the separator and the electrodes may be separated during a cell assembly process, resulting in distortion or deformation of an electrode assembly. That is, if the adhesion between the ceramic coated layer of the separator and the electrodes is insufficient, misalignment may occur between the electrode and the separator within a jelly roll during cell stacking. When a stack cell battery having misalignment as described above is operated, a short circuit between electrodes may occur due to local resistance due to the misalignment or physical damage due to continued use, resulting in safety problems such as fire.

Therefore, improving the adhesion between the ceramic coated separator and the electrode is very important for battery stability.

One way to improve the adhesion between the separator and the electrode is to form an adhesive organic layer on an inorganic particle layer of the ceramic coated separator. However, the organic layer may deteriorate air permeability, making thinning difficult. As a result, the adhesion strength with the electrode may decrease, and a blocking phenomenon occurs in which an adhesive organic layer is separated during a separator winding process. Therefore, deterioration of battery performance may occur due to a decrease in the ionic conductivity of the separator and thickness deviation when aligning the electrode assembly. The disclosed technology can be implemented in some embodiments to address these issues as will be discussed below.

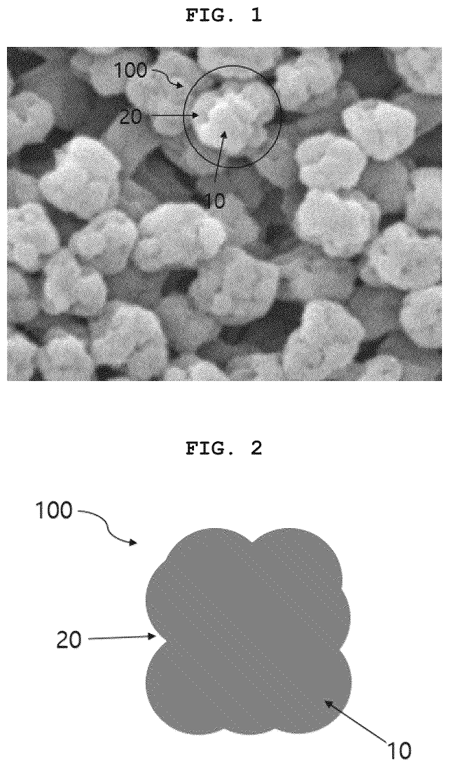

In some embodiments of the disclosed technology, an organic particle 100 may be a polymer particle, and as shown in FIGS. 1 and 2, may include a plurality of protrusion parts 10 and a plurality of valley parts 20 formed thereon. As an example, the organic particle may be an aggregate of a plurality of polymerized primary particles aggregated with each other by surface melting, that is, a secondary particle. The plurality of protrusion parts 10 and the plurality of valley parts 20 may be formed by aggregating or agglomerating the primary particles. In some implementations, a binder particle in a secondary particle form may refer to a particle form including a plurality of protrusion parts corresponding to a part of the primary particles and a valley or a shrunk cavity formed between the protrusion parts. For example, the binder particle may include a plurality of convex protrusion parts in a primary particle form, e.g., 3 or more, 4 or more, 5 or more, 6 or more, or 8 or more convex protrusion parts, and a plurality of valley parts or depression parts formed between the protrusion parts.

In some embodiments of the disclosed technology, the organic particle may be a primary particle having a plurality of protrusion parts and a plurality of valley parts.

The protrusion parts and the valley parts of the organic particle may have irregular sizes and shapes. In some implementations, the term “irregular” refers to substantially not straight, substantially non-uniform or uneven, or substantially asymmetrical. In some implementations, the term “protrusion part” refers to a protruded part on the surface of the particle (see 10 in FIGS. 1 and 2). In some implementations, the “valley or depression part” refers to a concavity or depression on the surface of the particle. In some implementations, the “valley or depression part” refers to a concavity formed by a height difference from the center of the organic particle between the plurality of protrusion parts (see 20 in FIGS. 1 and 2).

In some embodiments of the disclosed technology, “Dn” (n is a real number) refers to a diameter of a particle corresponding to n % as a volume-based integrated fraction: “Dn” represents a particle diameter where particles with a diameter less than Dn are n % of the total particles. For example, “D50” refers to a particle diameter below which 50% of the total particles can be found. For example, “D90” refers to a particle diameter below which 90% of the total particles can be found. For example, “D10” refers to a particle diameter below which 10% of the total particles can be found. The Dn may be derived from the results of a particle size distribution obtained by collecting a sample of particles to be measured in accordance with the standard of ISO 13320-1 and performing analysis using a particle size analyzer (e.g., S3500, Microtrac).

The separator based on some embodiments of the disclosed technology may be a separator including: a porous substrate; an inorganic particle layer disposed on at least one surface of the porous substrate and including inorganic particles connected to each other to form pores between the inorganic particles; and an adhesive layer disposed on the inorganic particle layer and including organic particles having a plurality of protrusion parts and a plurality of valley parts connected to each other to form pores.

Hereinafter, examples of the separator will be described in detail.

In an embodiment, the porous substrate may be a polyolefin-based porous substrate such as polyethylene and polypropylene, but the disclosed technology is not particularly limited thereto, and all porous substrates for a separator of an electrochemical device may be used. In an example embodiment, the porous substrate may be manufactured as a film or sheet, but the disclosed technology is not particularly limited thereto. As an example, the porous substrate includes polyolefin such as polyethylene and polypropylene and may use a multilayer of two or more layers.

In an embodiment, the porous substrate may have a thickness of, for example, 1 μm or more, 2 μm or more, 3 μm or more, 4 μm or more, 5 μm or more, or 6 μm or more. The upper limit is not limited, but for example, may be 100 μm or less, 50 μm or less, 30 μm or less, 20 μm or less, 15 μm or less, 12 μm or less, or a value between the numerical values, and unlimitedly, may be 1 to 100 μm, or 3 to 50 μm, 5 to 20 μm, or 5 to 15 μm for implementing a high capacity battery.

In an embodiment, the inorganic particle layer may include inorganic particles and an organic binder that can connect the inorganic particles to each other, and may be a porous inorganic particle layer in which the inorganic particles are connected and fixed by the organic binder to form pores between the inorganic particles. In an example embodiment, the inorganic particle layer is disposed on one or both surfaces of the porous substrate at an area fraction of 60% or more, 70% or more, 80% or more, or 90% or more based on the entire surface of the porous substrate. In one example, the inorganic particle layer is disposed on one or both surfaces of the porous substrate at an area fraction of 100% except in cases where there are some defects.

In an embodiment, the inorganic particle layer may be disposed on one or both surfaces of the porous substrate. In an example where the inorganic particle layer is disposed on both surfaces of the porous substrate, the thicknesses of the inorganic particle layer disposed on one surface and the other surface may be the same or different.

In an embodiment, the inorganic particle layer disposed on one surface of the porous substrate may have a thickness of more than 0 μm, 0.1 μm or more, 0.2 μm or more, 0.3 μm or more, 0.4 μm or more, or 0.5 μm or more and 5 μm or less, 4 μm or less, 3 μm or less, 2 μm or less, or a value between the numerical values. Specifically, the inorganic particle layer may have a thickness of more than 0 μm and 5 μm or less, 0.1 to 5 μm, 0.2 to 3 μm, or 0.5 to 2 μm, but the disclosed technology is not limited thereto.

In an embodiment, the inorganic particles are added to improve heat resistance of the separator and the disclosed technology is not particularly limited to a specific type of inorganic particle. In an example, the inorganic particles may include one or more of metal hydroxides, metal oxides, metal nitrides, and metal carbides. As an example, the inorganic particles may include any one or two or more selected from the group consisting of SiO₂, SiC, MgO, Y₂O₃, Al₂O₃, CeO₂, CaO, ZnO, SrTiO₃, ZrO₂, TiO₂, AlO(OH), or others, but the disclosed technology is not limited thereto. In some embodiments, in order to improve the stability of a battery, the inorganic particles may be metal hydroxide particles such as boehmite, pseudo-boehmite, aluminum hydroxide, and magnesium hydroxide, but the disclosed technology is not limited thereto.

In an embodiment, when boehmite is used as the inorganic particles, boehmite may have a specific surface area (BET) of 10 m²/g or more or 15 m²/g or more, but the disclosed technology is not particularly limited thereto.

In an embodiment, the inorganic particles may have D50 of more than 0 μm, 0.05 μm or more, 0.1 μm or more and 5 μm or less, 3 μm or less, 2 μm or less, 1 μm or less, 0.5 μm or less, or a value between the numerical values. For example, the D50 may be more than 0 μm and 5 μm or less, more than 0 μm and 3 μm or less, 0.05 μm or more and 2 μm or less, 0.1 μm or more and 1 μm or less, or 0.1 μm or more and 0.5 μm or less.

In an embodiment, the type of organic binder of the inorganic particle layer is not limited, as long as the organic binder connects the inorganic particles to each other to form a porous inorganic particle layer in which a space between the inorganic particles is formed. As an example, the organic binder may be a particle form or a non-particle form. In an example where the organic binder is a particle form, it may be in a particle form distinguishable from the organic particle having a plurality of protrusion parts and a plurality of valley parts. In addition, the organic binder may be a water-based latex.

Examples of the organic binder may include any one or two or more selected from the group consisting of acryl-based polymers such as polymethylmethacrylate, polybutylacrylate, and polyacrylonitrile; (3-aminopropyl)triethoxysilane, (3-aminopropyl)trimethoxysilane, (3-glycidyloxypropyl)trimethoxysilane, and oligomers thereof, or silane-based compounds prepared therefrom; styrene butadiene rubber; carboxylmethylcellulose (CMC); polyvinylidene fluoride (PVdF); polyvinylprrolidone (PVP); and polyvinylaccetate (PVAc), but the disclosed technology is not limited thereto.

A content of the organic binder may be 0.1 to 30 parts by weight, 0.2 to 10 parts by weight, or 0.2 to 5 parts by weight, with respect to 100 parts by weight of the inorganic particles, but the disclosed technology is not limited thereto.

The inorganic particle layer may be manufactured by disposing an inorganic particle layer on a porous substrate, and the disclosed technology is not particularly limited. As an example, the inorganic particle layer may be formed on the porous substrate by preparing a slurry of inorganic particles and water including an organic binder or an organic solution, and applying the slurry on one or both surfaces of the porous substrate by one of slot die coating, roll coating, spin coating, dip coating, bar coating, die coating, slit coating, and inkjet printing or a combination thereof.

Next, examples of the adhesive layer and the organic particles forming the adhesive layer will be described in detail.

In some embodiments of the disclosed technology, the adhesive layer may be a porous layer. The adhesive layer is formed by applying a composition including the organic particles illustrated in FIGS. 1 and 2. By including the organic particles in a specific form, (1) the adhesive layer has excellent adhesion to an electrode even in a thin film form, specifically at a thickness of 20 μm or less, 10 μm or less or 5 μm or less, (2) even after forming the adhesive layer, the increase in transmittance due to the adhesive layer is small as compared to the transmittance of the porous substrate itself, and (3) the adhesive layer does not cause blocking or clogging issues that can occur during battery assembly. In addition, a separator having better adhesion to an electrode as compared to the case of using general spherical organic particles may be provided.

In some embodiments, the organic particle may be in the form of a secondary particle in which primary particles are aggregated by melting on the surface. For example, the organic particle in the form of a secondary particle may include a plurality of protrusion parts corresponding to a part of the primary particles and a valley or a shrunk cavity formed between the protrusion parts. In some embodiments, the organic particle may be a single particle having a plurality of convex protrusion parts and a plurality of parts or a plurality of valleys between the protrusion parts.

The organic particle is not particularly limited, but in some embodiments, the organic particle may be an organic particle in a secondary particle form having a D50 particle diameter of 0.1 to 1.5 μm, 0.2 to 1.5 μm, or 0.3 to 1 μm. A typical form of the binder particle in a secondary particle form may be a particle form in which a plurality of polymerized primary particles are melted with each other, for example, melted on the surface and aggregated, so that the surface of the aggregate is protruded and depressed by the primary particles, as shown in FIG. 1. As another example, the binder particle may be in the form of a single particle in which a plurality of valleys or a plurality of shrunk cavity parts are formed among three or more convex protrusion parts in the single particle. For example, the binder particle may be in the form of a single particle in which 3 or more, 4 or more, 5 or more, or 6 or more convex protrusion parts are formed on the surface of the organic particle and a plurality of valleys or a plurality of shrunk cavity parts are formed between the protrusion parts.

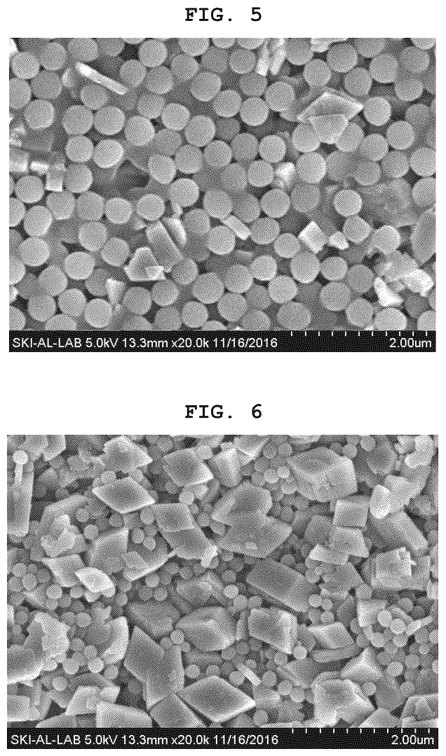

In some embodiments of the disclosed technology, the organic particles having the specified shape, and preferably also having the specified size, may significantly improve adhesion to an electrode, air permeability, and anti-blocking properties even in a smaller amount than the organic particle having a spherical shape as in FIG. 5.

In addition, an average particle diameter (D50) of the organic particles is not particularly limited as long as the particle has the above shape. In some implementations, the average particle diameter (D50) of the organic particles may be 10 μm or less, 5 μm or less, 2 μm or less, 1 μm or less, 0.5 μm or less and 0.1 μm or more, 0.3 μm or more, 0.5 μm or more. In some example, the average particle diameter (D50) of the organic particles may be 0.1 to 10 μm. In some example, the average particle diameter (D50) of the organic particles may be 0.1 to 2 μm. In some example, the average particle diameter (D50) of the organic particles may be 0.1 to 1.5 μm. In some example, the average particle diameter (D50) of the organic particles may be 0.2 to 1.0 μm.

In the range of the average particle diameter, a binding effect with the inorganic particles and adhesive strength with an electrode may be significantly improved. In particular, when the organic particles have a size of 0.1 to 1.5 μm, a blocking phenomenon, in which the adhesive layers block each other during a transfer or lamination process or an adhesive is adhered on other areas in contact with the adhesive layer to release the adhesive layer on the inorganic particle layer, is significantly decreased, adhesive strength with an electrode is dramatically increased, and also thinning is possible.

In an embodiment, as article size distribution of the organic particles, a D10/D90 value may be 0.3 or more, 0.4 or more and 0.9 or less, 0.8 or less, or a value between the numerical values. Otherwise, the D10/D90 value may be 0.3 to 0.9 or 0.4 to 0.8. When the particle size distribution of the organic particles is satisfied, the content of the organic particles for securing electrode adhesive strength may be further decreased, thereby securing air permeability and anti-blocking properties.

In an embodiment, a ratio of the average particle diameter of the organic particles to the average particle diameter (D50) of the inorganic particles may be 0.5 or more, 0.6 or more, 0.7 or more and 3 or less, 1.7 or less, 1.5 or less, 1.3 or less, 1.0 or less, or a value between the numerical values, and the content of the organic particles introduced to surface irregularities or pores of the inorganic particle layer may be further decreased, thereby securing air permeability and anti-blocking properties. In some embodiments, the average diameter of the organic particles/the average diameter of the inorganic particles may be 0.5 to 3, 0.5 to 2, 0.5 to 1.7, 0.5 to 1.5, 0.6 to 1.3, or 0.7 to 1.0.

In an embodiment, the adhesive layer may include 70 wt % or more, 80 wt % or more, 90 wt % or more, 95 wt % or more, 99 wt % or more, or 100% of the organic particles, based on the total weight of the adhesive layer, in order to provide a separator having excellent electrode adhesion, anti-blocking properties, and air permeability even at a small thickness. In some embodiments, the upper limit of the content of the organic particles in the secondary particle form is not particularly limited.

In an embodiment, in the separator, the organic particles forming the adhesive layer formed on the inorganic particle layer have a specific form as discussed above with reference to FIG. 1. In this way, the separator may have excellent physical properties such as electrode adhesion, air permeability, and anti-blocking properties, as compared to the separator using organic particles having a spherical or circular shape without valleys as shown in FIG. 5. Therefore, the composition of the organic particles of the disclosed technology is not particularly limited, and any composition of organic particles may be used.

As an example, the organic particles may be formed of a crosslinked or non-crosslinked particulate acryl-based polymer or fluorinated polymer, or may have a core-shell structure. The particulate acryl-based polymer having a core-shell structure may be obtained by including and polymerizing an acryl-based monomer and other comonomers and a crosslinking agent as required on the surface of crosslinked particles or a core rubber, but the disclosed technology is not particularly limited thereto.

The organic particles in the specific form based on an embodiment may significantly improve electrode adhesive strength with a small amount by the structural characteristic, and when they have a glass transition temperature specified below, anti-blocking properties may be further improved. In this case, the glass transition temperature (Tg) of the organic particles may be 50° C. or higher, 60° C. or higher and 90° C. or lower, 80° C. or lower, 70° C. or lower, or a value between the numerical values, and for example, may be 50 to 90° C., 55 to 75° C., or 60 to 70° C., but the disclosed technology is not limited thereto.

In an embodiment, the adhesive layer may optionally further include other components known to be added to an electrode adhesive organic layer of a separator in the art, such as a lubricant and a surfactant, in addition to the organic particles, but the disclosed technology is not particularly limited thereto.

In an embodiment, the adhesive layer is a porous particle layer in which the organic particles are connected and fixed to each other, may have an area fraction of 60% or more, 70% or more, 80% or more, or 100% based on the entire surface of the inorganic particle layer, and may be laminated at 100% except for unusually occurring defects. In an example embodiment, the porous inorganic particle layer is formed on the porous substrate, and then the porous adhesive layer in the above form and size may be laminated on the porous inorganic particle layer to further improve air permeability and ion conductivity of the separator, but the disclosed technology is not particularly limited thereto.

In an embodiment, the adhesive layer may have a thickness of more than 0 μm, 0.1 μm or more, 0.2 μm or more, 0.3 μm or more and 2 μm or less, 1.5 μm or less, 1 μm or less, 0.9 μm or less, 0.7 μm or less, or a value between the numerical values, and may have a thickness of more than 0 μm and 2 μm or less, or 0.1 to 1 μm for implementing a high capacity battery.

In an embodiment, a total thickness of the separator in which the inorganic particle layer and the adhesive layer are disposed, respectively, on one or both surfaces of the porous substrate may be 5 μm or more, 6 μm or more, 7 μm or more, 8 μm or more, 9 μm or more, 10 μm or more, 15 μm or more, 20 μm or more, 30 μm or more and 50 μm or less, 30 μm or less, 20 μm or less, 15 μm or less, or a value between the numerical values. The total thickness of the separator may be 5 to 50 μm, and may be 5 to 25 μm or 7 to 20 μm for implementing a high capacity battery, but is not particularly limited thereto.

In an embodiment, the content of the organic particles in the adhesive layer may be 0.2 g/m² or more, 0.5 g/m² or more, 1 g/m² or more and 2.0 g/m² or less, 1 g/m² or less, 0.5 g/m² or less, or a value between the numerical values. In one example, the content of the organic particles in the adhesive layer may be 0.2 to 1.0 g/m².

A method of preparing the organic particles in the specific form is not particularly limited, but in an embodiment, various radical polymerizable monomers such as acryl-based or fluorine-based monomers are polymerized by a polymerization method such as emulsion polymerization and suspension polymerization to prepare a polymerization solution of primary particles, which is sprayed and dried at a high temperature of 200° C. to 300° C. for several seconds and classified by size, thereby preparing the organic particles in an aggregate form in a secondary particle form, or after emulsion polymerization, vacuum distillation is performed to remove unreacted monomers from polymer particles to form protrusion parts and valley parts, but the disclosed technology is not limited thereto.

The adhesive layer may be disposed on the inorganic particle layer using all methods known in the art, and the means is not particularly limited. As a non-limiting example, water is added to the organic particles and stirring is performed to prepare a slurry for an adhesive layer, and the prepared slurry is applied on the inorganic particle layer by one method of slot die coating, roll coating, spin coating, dip coating, bar coating, die coating, slit coating, and inkjet printing or a combined method thereof and dried to dispose the adhesive layer on the inorganic particle layer.

In an embodiment, the separator may have an electrode adhesive strength of 1.5 gf/15 mm or more, 2.0 gf/15 mm or more, 2.3 gf/15 mm or more, 2.5 gf/15 mm or more, or 3.0 gf/15 mm or more, the electrode adhesive strength being measured by laminating the separator on a carbon sheet having a thickness of 200 μm so that the adhesive layer of the separator faces the carbon sheet, adhering the separator by compression at 80° C., 20 MPa for 30 seconds with a heat press, and peeling off the separator at 180° using UTM equipment in accordance with ASTM D903. Otherwise, the electrode adhesive strength may be 1.5 gf/15 mm to 4.0 gf/15 mm or 2.0 to 4.0 gf/15 mm.

In an embodiment, the organic particles having the above form while having a high glass transition temperature simultaneously may be thinly applied in a small amount or well distributed even with an insufficient application area, thereby securing sufficient electrode adhesion even when applied on the inorganic particle layer and also improving anti-blocking properties.

For example, when two sheets of separators in which the porous substrate, the inorganic particle layer, and the adhesive layer are sequentially laminated are disposed so that the adhesive layers face each other, compression is performed at a temperature of 60° C. and a pressure of 7.5 MPa for 1 hour, and then whether the adhesive layer is partially or completely peeled off upon separation to cause blocking between separator surfaces is confirmed by SEM, excellent anti-blocking properties having no blocking occurrence confirmed may be secured.

The separator implemented based on an embodiment may have an amount of change in air permeability (AG) represented by the following equation of 50 sec/100 cc or less, 45 sec/100 cc or less, 40 sec/100 cc or less, 35 sec/100 cc or less or 30 sec/100 cc or less:

ΔG=G₁−G₂
wherein G₁ is a Gurley permeability of a separator in which an inorganic particle layer and an adhesive layer are sequentially laminated on both surfaces of a porous substrate, and G₂ is a Gurley permeability of the porous substrate itself. The Gurley permeability is measured using a densometer (e.g., Toyoseiki) in accordance with the standard of ASTM D 726, and its unit is sec/100 cc.

The separator implemented based on an embodiment may exhibit excellent electrode adhesion, anti-blocking properties, and air permeability.

In another embodiment, an electrochemical device may include the separator implemented based on some embodiments of the disclosed technology. The electrochemical device may be an energy storage device, and though it is not particularly limited, as a non-limiting example, may be a lithium secondary battery. Since the lithium secondary battery is well known and its configuration is also known, it will not described in detail in this document.

The lithium secondary battery based on one embodiment may include the separator described above between a positive electrode and a negative electrode. Herein, the positive electrode and the negative electrode may be all used without limitation as long as they are commonly used in the lithium secondary battery.

Hereinafter, some embodiments of the disclosed technology will be described in more detail, based on the examples and the comparative examples. However, the following examples and the comparative examples are only an example for describing the disclosed technology in more detail, and do not limit the disclosed technology in any way.

Hereinafter, a method of measuring the physical properties of the separator is as follows.

### 1. Electrode Adhesive Strength

Electrode adhesive strength was measured by laminating the separator on a carbon sheet (e.g., TOYO Tanso Korea, PF-20HP) having a thickness of 200 μm so that the adhesive layer of the separator faces the carbon sheet, adhering the separator by compression at 80° C., 20 MPa for 30 seconds with a heat press, and peeling off the separator at 180° using UTM equipment (e.g., INSTRON) in accordance with ASTM D903. When the adhesive strength of the adhesive layer of the separator was too low and even peeling off using UTM equipment was impossible, it was evaluated as “immeasurable”

### 2. Amount of Change in Air Permeability

Amount of change in air permeability, AG was calculated as follows:

ΔG=G₁−G₂
wherein G₁ is a Gurley permeability of a separator in which an inorganic particle layer and an adhesive layer are sequentially laminated on both surfaces of a porous substrate, and G₂ is a Gurley permeability of the porous substrate itself. The Gurley permeability was measured based on the standard of ASTM D726, using Densometer (e.g., Toyoseiki), and a time it took for 100 cc of air to pass a separator having an area of 1 square inch was recorded in seconds. The unit was sec/100 cc.

### 3. Anti-Blocking Properties

Two sheets of separators in which porous substrate-inorganic particle layer-adhesive layer were laminated were disposed so that the adhesive layers face each other, and compressed with a pressure of 7.5 MPa at a temperature of 60° C. for 1 hour. Next, when peeling at 180° was performed in accordance with ASTM D903, it was evaluated whether a phenomenon in which the adhesive layers were adhered to each other and partially or completely peeled off occurred. When the adhesive layers were even partially peeled off, blocking occurred, and when the adhesive layers were separated as they are without a peeling phenomenon, blocking did not occur. It was confirmed by SEM whether blocking occurred. When blocking occurrence was confirmed by SEM, it was evaluated as “NG”, and when no blocking occurrence was confirmed, it was evaluated as “OK”.

### 4. Method of Measuring Average Particle Diameter

Average particle diameter (D50), D10, and D90 were measured using S3500 available from Microtrac which is a particle size analyzer, in accordance with the ISO 13320-1 standard.

### 5. Glass Transition Temperature (Tg)

A melting point were measured by heating from at −50° C. to 300° C. at a heating rate of 20° C./min under a nitrogen atmosphere using DSC equipment available from TA (product name: Q200). Here, the measurement was performed by heating twice (1st, 2nd run, and cooling).

### 6. Thickness (μm)

The thickness was measured using a contact type thickness meter having a measurement precision of 0.1 μm. The measurement was performed at a measurement pressure of 0.63 N using TESA μ-Hite Electronic Height Gauge available from TESA.

### Example 1

### 1) Preparation of Composition for Adhesive Layer

An acryl-based latex (acryl-based latex in which methyl methacrylate and butyl methacrylate are polymerized) having an average particle diameter (D50) of 550 nm and a glass transition temperature (Tg) of 65° C. as the organic particles in the form in FIG. 1 was added to water so that the solid content was 5 wt %, and stirring was performed to prepare a uniformly mixed composition for an adhesive layer. Here, D10/D90 of the organic particles was 0.57.

### 2) Preparation of Slurry for Inorganic Particle Layer

3 parts by weight of an aqueous acryl-based binder (e.g., PVP K120, Ashland) and water were mixed with respect to 100 parts by weight of boehmite particles having D50 of 600 nm (e.g., Apyral AOH60, Nabaltec) to prepare a slurry having an inorganic particle content of 40 wt %.

### 3) Manufacture of Separator

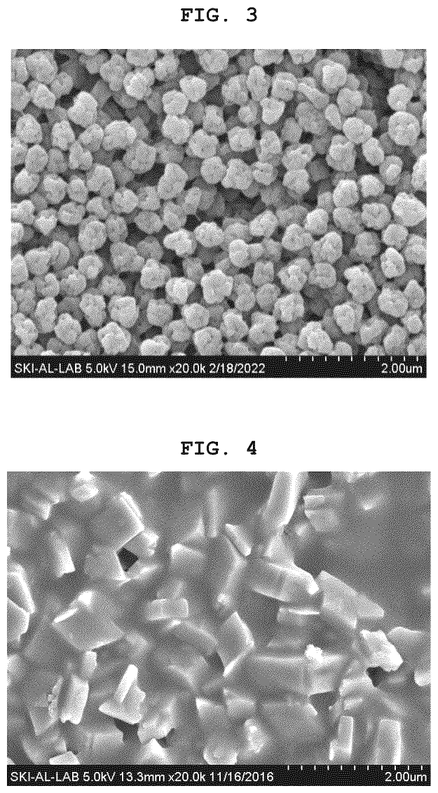

The slurry for an inorganic particle layer was applied on both surfaces of a polyolefin-based porous substrate having a Gurley permeability of 125 sec/100 cc and a thickness of 8.5 μm (e.g., ENPASS, SK Innovation) using two slot coating dies, and sufficiently dried at 40° C. to form an inorganic particle layer. Subsequently, the composition for an adhesive layer was applied on the inorganic particle layer and sufficiently dried at 40° C. to form an adhesive layer. The inorganic particle layer of the separator had a thickness of 1.5 μm, the adhesive layer had a thickness of 0.5 μm, and the separator had a total thickness of 12.5 μm. The content of the organic particles in the coated adhesive layer was 0.4 g/m². The photograph of the surface of the adhesive layer is shown in FIG. 3, and the physical properties are listed in Table 1.

### Example 2

A separator was manufactured in the same manner as in Example 1, except that D50 was 400 nm during preparation of the composition for an adhesive layer. The results are listed in Table 1.

### Example 3

A separator was manufactured in the same manner as in Example 1, except that an acryl-based latex having the composition of the organic particles and having D50 of 1.8 μm and a glass transition temperature (Tg) of 65° C. was coated at the content listed in Table 1. The results are listed in Table 1.

### Example 4

A separator was manufactured in the same manner as in Example 1, except that an acryl-based latex having the same composition as the organic particles during preparation of the composition for an adhesive layer and having D50 of 1.0 μm and a glass transition temperature (Tg) of 62° C. was coated at the content listed in Table 1. The results are listed in Table 1.

### Comparative Example 1

The process was performed in the same manner as in Example 1, except that the acryl-based latex was dissolved in an organic solvent and applied on the inorganic particle layer. The results are shown in FIG. 4 and Table 1.

### Comparative Example 2

A separator was manufactured in the same manner as in Example 1, except that a spherical acryl-based latex of FIG. 5 having D50 of 540 nm and a glass transition temperature (Tg) of 65° C. which was prepared by suspension polymerization using the same monomer as in Example 1 as completely spherical organic particles instead of the organic particles of Example 1 was coated at the content listed in Table 1. The results are shown in FIG. 5 and Table 1.

### Comparative Example 3

A separator was manufactured in the same manner as in Example 1, except that an acryl-based latex having D50 of 200 nm and a glass transition temperature (Tg) of 65° C. as completely spherical organic particles instead of the organic particles of Example 1 was coated at the content listed in Table 1. The results are shown in FIG. 6 and Table 1.

The results of evaluating the physical properties of the separators manufactured in the examples and the comparative examples were summarized and are shown in Table 1.

TABLE 1

| | | | | | | Amount of | |
|---|---|---|---|---|---|---|---|
| | | | | Average diameter of | Electrode | change in air | |
| | Organic particles | | | organic particles/ | adhesive | permeability | Anti-blocking |
| | D50 | Tg | Content | average diameter of | strength | ΔG | properties |
| | (nm) | (° C.) | (g/m²) | inorganic particles | (gf/15 mm) | (sec/100cc) | (OK/NG) |
| Example 1 | 550 | 65 | 0.4 | 0.92 | 2.7 | 27 | OK |
| Example 2 | 400 | 65 | 0.8 | 0.67 | 2.5 | 33 | OK |
| Example 3 | 1800 | 65 | 0.2 | 3.0 | 2.5 | 19 | NG |
| Example 4 | 1000 | 62 | 0.3 | 1.67 | 2.8 | 22 | OK |
| Comparative | 550 | 65 | 0.4 | — | Immeasurable | 86 | OK |
| Example 1 | | | | | | | |
| Comparative | 540 | 65 | 0.4 | 0.9 | Immeasurable | 27 | OK |
| Example 2 | | | | | | | |
| Comparative | 200 | 65 | 0.8 | 0.33 | Immeasurable | 38 | OK |
| Example 3 | | | | | | | |

Referring to the results of Table 1 and the drawings, it was confirmed that in Examples 1 and 2 in which the adhesive layer was formed of the organic particles in the form of secondary particles including convex protrusion parts on the surface and valley parts interposed between the protrusion parts, as shown in FIG. 3, and the average particle diameter ratio between the organic particles and the inorganic particles was between 0.5 and 1.5 and the size of the average particle diameter of the organic particles was 1.5 μm or less, electrode adhesion and anti-blocking properties were the best and the included adhesive layer was formed well on the inorganic particle layer.

In addition, it is shown that Example 4 having the average size of the organic particles of 1 μm and the ratio of organic particles/inorganic particles of 1.67 had electrode adhesion and anti-blocking properties which were inferior to Examples 1 and 2 but significantly better than the comparative examples, and Example 3 having the average size of 1.8 μm and the ratio of organic particles/inorganic particles of 3 showed inferior anti-blocking properties to Examples 1, 2, and 4, but better adhesion than the comparative examples.

However, Comparative Example 1 using the soluble acryl-based polymer had blocked pores on the surface as shown in FIG. 4 to have poor air permeability, and also had very low electrode adhesive strength. In addition, Comparative Examples 2 and 3 having a spherical adhesive layer had a spherical adhesive layer as shown in FIGS. 5 and 6, and in this case, had poor electrode adhesive strength and very poor anti-blocking properties.

The separator implemented based on some embodiments of the disclosed technology may have excellent electrode adhesion, anti-blocking properties, or air permeability even at a small thickness.

The separator implemented based on an example embodiment may have an electrode adhesive strength of 1.5 gf/15 mm or more, 2.0 gf/15 mm or more, 2.3 gf/15 mm or more, 2.5 gf/15 mm or more, or 3.0 gf/15 mm or more, the electrode adhesive strength being measured by laminating the separator on a carbon sheet having a thickness of 200 μm so that the adhesive layer of the separator faces the carbon sheet, adhering the separator by compression at 80° C., 20 MPa for 30 seconds with a heat press, and peeling off the separator at 180° using UTM equipment in accordance with ASTM D903. As an example, the electrode adhesive strength may be 1.5 gf/15 mm to 4.0 gf/15 mm. In an example embodiment, sufficient electrode adhesion may be secured even when organic particles having a shape of secondary particles in which the surface of primary particles of a polymer having a high glass transition temperature is melted and aggregated are included in a relatively small amount.

The separator implemented based on an example embodiment may secure excellent electrode adhesion even at a small thickness and also may have excellent anti-blocking properties. For example, two separators in which porous substrate-inorganic particle layer-adhesive layer are laminated are disposed by lamination so that the adhesive layers face each other, and then compressed with a pressure of 7.5 MPa at a temperature of 60° C. for 1 hour. Next, when the adhered part is peeled off and whether the adhesive layer is partially or completely peeled off to cause blocking between separator surfaces is confirmed by SEM, the separator may have excellent blocking prevention performance without causing blocking in which the adhesive layers are partially released from their separators.

In an example embodiment, the separator may have excellent air permeability even with its multilayer structure in which the adhesive layer is disposed on the inorganic particle layer, and an amount of change in air permeability represented by the following equation may be 50 sec/100 cc or less, 40 sec/100 cc or less, 35 sec/100 cc or less, or 30 sec/100 cc or less.

$$Δ G = {G}_{1} - {G}_{2}$$

wherein G₁ is a Gurley permeability of a separator in which an inorganic particle layer and an adhesive layer are sequentially laminated on both surfaces of a porous substrate, and G₂ is a Gurley permeability of the porous substrate itself. The Gurley permeability is measured using a densometer (e.g., Toyoseiki) in accordance with the standard of ASTM D 726, and its unit is sec/100 cc. In addition, even the separator in which the inorganic particle layer and the adhesive layer are sequentially laminated on one surface of the porous substrate may satisfy the amount of change in air permeability.

In the separator implemented based on an example embodiment, two or more of electrode adhesion, anti-blocking properties, and air permeability may be excellent, and more preferably, all of electrode adhesion, anti-blocking properties, and air permeability may be excellent.

The disclosed technology can be implemented in rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery used in various power sources and power supplies, thereby mitigating climate changes in connection with uses of power sources and power supplies. Lithium secondary batteries based on the disclosed technology can be used to address various adverse effects such as air pollution and greenhouse emissions by powering electric vehicles (EVs) as alternatives to vehicles using fossil fuel-based engines and by providing battery-based energy storage systems (ESSs) to store renewable energy such as solar power and wind power.

Only a few implementations and examples are described and other implementations, enhancements and variations can be made based on what is described and illustrated in this patent document.

What is claimed is:

1. A separator comprising:
a porous substrate;
an inorganic particle layer disposed on at least one surface of the porous substrate and including inorganic particles connected to each other to form pores between the inorganic particles; and
an adhesive layer disposed on the inorganic particle layer and including organic particles having a plurality of protrusion parts and a plurality of valley parts connected to each other to form pores.

2. The separator of claim 1, wherein a ratio of an average particle diameter (D50) of the organic particles to an average particle diameter (D50) of the inorganic particles is 0.5 to 3, where D50 is a particle diameter below which 50% of the total particles are found.

3. The separator of claim 1, wherein the organic particles have D50 of 0.1 to 2 μm.

4. The separator of claim 1, wherein a particle size distribution of the organic particles (D10/D90) is 0.3 to 0.9, where D10 is a particle diameter below which 10% of the total organic particles are found, and D90 is a particle diameter below which 90% of the total organic particles are found.

5. The separator of claim 1, wherein the organic particles have a glass transition temperature (Tg) of 50 to 90° C.

6. The separator of claim 1, wherein the adhesive layer has a thickness ranging from 0 μm to 2 μm.

7. The separator of claim 1, wherein the organic particles are at least one of: secondary particles in which primary particles are aggregated with each other by surface melting to form a plurality of protrusion parts and a plurality of valley parts; or primary particles having a plurality of protrusion parts and a plurality of valley parts on a surface of the primary particles.

8. The separator of claim 1, wherein the adhesive layer includes 70 wt % or more of the organic particles based on the total weight of the adhesive layer.

9. The separator of claim 1, wherein the adhesive layer includes 0.2 to 2.0 g/m² of the organic particles.

10. The separator of claim 1, wherein the separator has an electrode adhesive strength of 1.5 gf/15 mm to 4.0 gf/15 mm, wherein the electrode adhesive strength is measured by laminating the separator on a carbon sheet having a thickness of 200 μm so that the adhesive layer of the separator faces the carbon sheet, adhering the separator by compression at 80° C., 20 MPa for 30 seconds with a heat press, and peeling off the separator at 180° using universal testing machine (UTM) equipment in accordance with ASTM D903.

11. The separator of claim 10, wherein the separator has an amount of change in air permeability ΔG of 50 sec/100 cc or less as measured by the following equation:
$$Δ G = {G}_{1} - {G}_{2}$$
wherein G₁ is a Gurley permeability of a separator in which an inorganic particle layer and an adhesive layer are sequentially laminated on both surfaces of a porous substrate, and G₂ is a Gurley permeability of the porous substrate itself, wherein the Gurley permeability is measured using a densometer in accordance with the standard of ASTM D 726, wherein a unit of the Gurley permeability is sec/100 cc.

12. The separator of claim 11, wherein when two sheets of separators are disposed so that the adhesive layers face each other, compressed with a pressure of 7.5 MPa at a temperature of 60° C. for 1 hour, and peeled off at 180° in accordance with ASTM D903, the adhesive layers are separated as they are without a phenomenon in which the adhesive layers are adhered to each other and partially or completely peeled off, and blocking is not caused.

13. An electrochemical device comprising a separator comprising:
a porous substrate;
an inorganic particle layer disposed on at least one surface of the porous substrate and including inorganic particles connected to each other to form pores between the inorganic particles; and
an adhesive layer disposed on the inorganic particle layer and including organic particles having a plurality of protrusion parts and a plurality of valley parts connected to each other to form pores.

14. The electrochemical device of claim 13, wherein a ratio of an average particle diameter (D50) of the organic particles to an average particle diameter (D50) of the inorganic particles is 0.5 to 1.5, where D50 is a particle diameter below which 50% of the total particles are found.

15. The electrochemical device of claim 13, wherein the organic particles have D50 of 0.1 to 1.5 μm.

16. The electrochemical device of claim 13, wherein a particle size distribution of the organic particles (D10/D90) is 0.3 to 0.9, where D10 is a particle diameter below which 10% of the total organic particles are found, and D90 is a particle diameter below which 90% of the total organic particles are found.

17. The electrochemical device of claim 13, wherein the organic particles have a glass transition temperature (Tg) of 50 to 90° C.

18. The electrochemical device of claim 13, wherein the adhesive layer has a thickness ranging from 0 μm to 2 μm.

19. The electrochemical device of claim 13, wherein the organic particles are at least one of: secondary particles in which primary particles are aggregated with each other by surface melting to form a plurality of protrusion parts and a plurality of valley parts; or primary particles having a plurality of protrusion parts and a plurality of valley parts on a surface of the primary particles.

20. The electrochemical device of claim 13, wherein the adhesive layer includes 70 wt % or more of the organic particles based on the total weight of the adhesive layer.
